(19) United States
(12) Patent Application Publication
(10) Pub. No.: US 2025/0298375 A1
(43) Pub. Date: Sep. 25, 2025

(54) ELECTROMECHANICAL HOROLOGICAL MOVEMENT COMPRISING A WHEEL SET CARRYING A DISPLAY MEMBER AND PROVIDED WITH A BRAKING DEVICE

(71) Applicant: ETA SA Manufacture Horlogère Suisse, Grenchen (CH)

(72) Inventors: Raphaël COURVOISIER, Corcelles (CH); Baptist WYSSBROD, Nidau (CH)

(73) Assignee: ETA SA Manufacture Horlogère Suisse, Grenchen (CH)

(21) Appl. No.: 19/060,117

(22) Filed: Feb. 21, 2025

(30) Foreign Application Priority Data
Mar. 25, 2024 (EP) 24165830.1

(51) Int. Cl. G04B 13/00

(52) U.S. Cl. CPC G04B 13/00

(57) ABSTRACT

An electromechanical horological movement (2) including an electromechanical motor (54), a display wheel set (30) arranged to be rotated by the electromechanical motor and including an arbor (36) intended to carry a display hand (48), and a braking device associated with the display wheel set and including a braking spring (10) and a washer (8) arranged between the braking spring and the arbor of the display wheel set, the braking spring being arranged so as to be able to generate, via the washer against which this braking spring presses, a braking torque on the display wheel set, as soon as this display wheel set is subjected to a rotary drive torque. The washer and the braking spring are arranged so that the washer remains stationary and non-rotating in normal operation.

### CROSS REFERENCE TO RELATED APPLICATION

This application claims priority to European Patent Application No. 24165830.1 filed Mar. 25, 2024, the entire contents of which are incorporated herein by reference.

### TECHNICAL FIELD OF THE INVENTION

The present invention relates to an electromechanical horological movement comprising a wheel set carrying a display member, in particular a hand, and provided with an anti-trembling device, also referred to as an anti-float device, formed by a braking device acting on the wheel set to prevent the display member from trembling when rotating and also from floating during the time intervals and periods when the display member is stationary.

### TECHNOLOGICAL BACKGROUND

Swiss patent document CH 580301 discloses an anti-trembling device for a horological wheel set, in particular a chronograph wheel set, also referred to hereinafter as a “chrono wheel set”, comprising an arbor fitted with a pinion, which meshes with a clutch wheel, referred to hereinafter as the “driving wheel”, forming a coupling device for a chronograph mechanism. It should be noted that an arbor fitted with pivots to guide the rotation thereof is also referred to as a ‘shaft’ in watchmaking. The anti-trembling device for the seconds hand of the chronograph function is formed by a friction device comprising a wire spring bearing obliquely against said arbor, which has a frustoconical shoulder for this purpose, the wire spring having a bearing point in the angle formed by this shoulder and a circular cylindrical part, the diameter whereof corresponds to the minimum diameter of the shoulder, and exerting, at this point, an oblique force on said arbor, so that the toothing of the pinion presses against the driving wheel and so that a lower annular surface of the arbor, opposite said shoulder and orthogonal to the axis defined by the arbor, presses axially against a bearing in which the chronograph wheel set pivots. The spring is designed to be rectilinear in the absence of stress. This spring is fastened to the frame of the movement on the side of a first end, whereas a part of the side of the second end is under tension and presses against the arbor, as explained above.

For a number of reasons, this anti-trembling device poses a problem concerning control of the moment of frictional force applied to the chronograph wheel set. Moreover, there is no way of adjusting this moment of frictional force. Subsequently, when the chronograph hand (chrono hand) is removed, the spring is subjected to an axial force which can damage this spring.

German patent document DE 6800934 U describes a solution for improving control of the moment of frictional force applied to a seconds wheel set. According to the teaching of this document, the wire spring or strip spring is fastened, at its first end part, by a riveting technique to a plate which is held suspended by a rivet having a head, with a screw-like slot, arranged on one side of a bar which is opposite the side where the plate is located. The rivet has an intermediate cylindrical part which is inserted into a hole in the bar with a friction fit allowing the rivet and thus the plate and thus the first end part of the spring to undergo a certain rotation with the aid of a tool. The second end part of the friction spring is free and bears radially against a plastic washer that is force-fitted/press-fitted onto the arbor of the seconds wheel set, this washer having a lateral groove in which the second end part of the spring is placed. This system is very difficult to assemble in the horological movement. Firstly, the friction spring must be fastened to the plate, by inserting its first end part into a slot and then pressing material onto the two edges of this slot to perform a first riveting operation. The plate with the friction spring must then be brought to an inner side of the bar after inserting the rivet into the hole in the bar from the other side. The end of the rivet must then be crushed and a second riveting operation must be carried out to fasten the plate to the rivet. It can be seen that, at each stage of assembling the friction spring to the plate and then to the bar, via two successive riveting operations, there is a high risk of damaging the friction spring. Finally, the bar, plate and friction spring assembly is assembled in the horological movement, a priori simultaneously with the insertion of a pivot of the arbor of the seconds wheel set, carrying the grooved washer, into a bearing arranged in the bar concerned. Such an assembly requires that the spring not be stacked on top of the grooved washer, as the spring is rigidly connected to the bar and as the grooved washer, which is designed to receive the free end of the spring under tension, is rigidly connected to the arbor. There is thus a first assembly/disassembly position for the spring and a second working position in which the free end of the spring is brought into the groove in the washer and the spring is tensioned. To move from one position to the other, the watchmaker has to use a tool to act on the rivet head, which causes the spring to lose the tension set when it is removed for maintenance. As a result, each time the seconds wheel set is assembled, the moment of braking force must be readjusted. The assembly method described here is difficult and time-consuming to implement.

Moreover, this anti-trembling device does not provide a perfect solution to the problem of adjusting the moment of force applied to the seconds wheel set to prevent it from trembling, as the friction force is defined in particular by the profile of the lateral groove of the plastic washer and the shape of the end of the spring which is inserted into this groove and presses radially against the washer. Such a friction force is difficult to control and reproduce, as it is highly dependent on the dimensions of the spring and the groove, their respective configurations and their respective surface finishes. Another problem arises from the fact that assembling an intermediate part on the arbor of the seconds wheel set will increase the radial shake of the wheel set, and thus cause greater variation than in the absence of such an intermediate part, particularly if the spring was bearing directly on a conventional arbor with less radial shake. Moreover, in the event of vibrations or impacts to the watch, the second free end of the spring could become detached from the grooved washer, and would no longer guarantee a constant braking torque. Worse still, in the event of a violent impact, the spring fastening plate, which is held in place solely by friction, could move angularly and alter the brake setting.

### SUMMARY OF THE INVENTION

The purpose of the present invention is to overcome the problems of the prior art mentioned above in the case of an electromechanical movement in which at least one display wheel set, intended to carry a display member, also has a trembling/floating problem due to the fact that this display wheel set is not subjected to a retention torque outside the time intervals in which it is driven rotatably by a horological motor. In particular, the invention proposes an anti-trembling/anti-floating device for a display wheel set, driven rotatably by an electromechanical motor, which is easy to mount and which can, in a preferred alternative embodiment, be mounted in a preliminary step to the mounting of the display wheel set in question.

To this end, the present invention relates to an electromechanical horological movement comprising an electromechanical motor, a display wheel set arranged so as to be able to be driven rotatably by the electromechanical motor and comprising an arbor intended to carry a display member, and a braking device associated with the display wheel set and comprising a braking spring and an intermediate part arranged between the braking spring and the arbor of the display wheel set. The braking spring is arranged so as to be able to generate, via the intermediate part against which this braking spring presses, a braking torque on the display wheel set, as soon as this display wheel set is subjected to a rotary drive torque. The intermediate part and the braking spring are arranged so that the intermediate part remains stationary and non-rotating in normal operation, this intermediate part having a lateral surface pressing against a surface of revolution of said arbor, and a bearing surface against which the braking spring exerts an overall pressing force towards the arbor in order to generate, between the lateral surface and the surface of revolution, a friction force that generates said braking torque.

In a preferred general alternative embodiment, the intermediate part exerts exclusively radial pressure on the arbor of the display wheel set.

In a main embodiment, the braking spring is a wire spring or a strip spring whose longitudinal axis lies in a geometric plane parallel to a general plane of the movement.

In one main embodiment, the movement comprises an eccentric whose axis of rotation is perpendicular to said geometric plane and which is arranged to press radially against the braking spring so as to be able to vary, by rotation about its axis of rotation, said radial overall pressing force exerted by the braking spring on the intermediate part.

### BRIEF DESCRIPTION OF THE FIGURES

The invention will be described in more detail hereafter using the accompanying drawings, given by way of examples that are in no way limiting, wherein:

FIG. 1 is a bottom view of a main embodiment of an electromechanical horological movement according to the invention, certain parts of this movement being omitted to better show a braking device according to the invention;

FIG. 2 is an enlarged partial view of the electromechanical horological movement in FIG. 1, showing the braking device provided according to the invention;

FIG. 3 is a perspective view of the braking device of the main embodiment in FIGS. 1 and 2;

FIG. 4 is a horizontal cross-sectional view of the electromechanical horological movement taken through the braking device in FIGS. 2 and 3, which in this case is in a pre-assembled state following a preliminary step of assembling the braking device, which step precedes the assembly of the display wheel set in the movement;

FIG. 5 is a partial cross-sectional view, taken along the cutting line V-V in FIG. 4, of the horological movement partially assembled following said preliminary step, this cross-sectional view passing through the central axis of a tube intended to receive part of the arbor of the display wheel set;

FIG. 6 is a cross-sectional view, taken along the cutting line VI-VI in FIG. 2, of the electromechanical horological movement in FIG. 1, this view passing through the axis of rotation of the arbor of the display wheel set and showing the braking device once the display wheel set has been mounted in the movement;

FIG. 7 diagrammatically shows a partial view of a particular alternative embodiment to the main embodiment;

FIGS. 8A and 8B diagrammatically show a partial view of two advantageous alternative embodiments to the main embodiment;

FIG. 9 diagrammatically shows a partial view of another particular alternative embodiment to the main embodiment; and

FIG. 10 diagrammatically shows a partial view of a second embodiment of the invention.

### DETAILED DESCRIPTION OF THE INVENTION

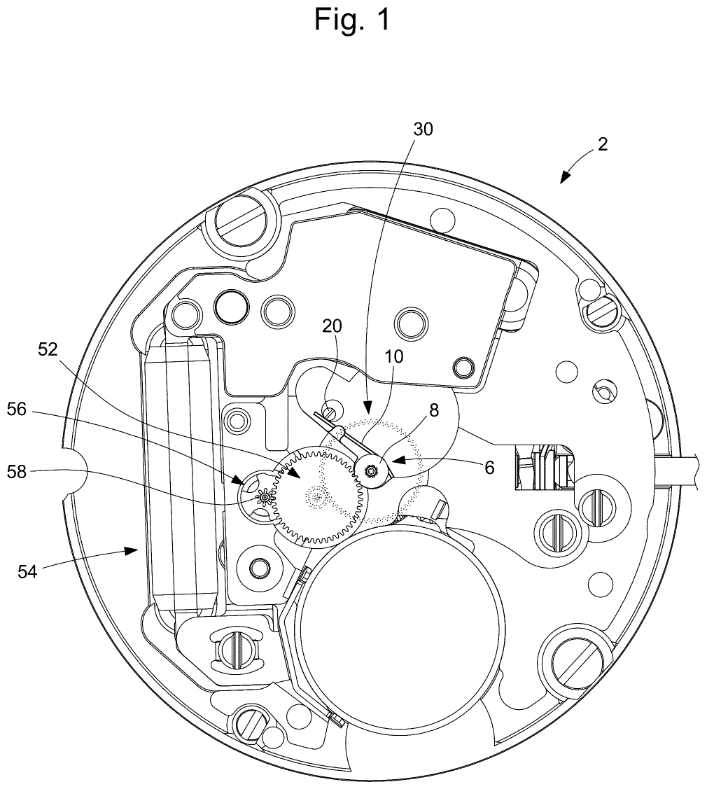

A main embodiment of an electromechanical horological movement 2 according to the invention will be described below with reference to FIGS. 1 to 6.

The electromechanical horological movement 2 comprises:
an electromechanical motor 54, in particular of the stepper type, comprising a rotor 56 fitted with a pinion 58,
a first wheel set 30, forming a display wheel set, intended to carry a display member 48, in particular a seconds hand, and driven rotatably by a second wheel set 52, which is driven rotatably by the rotor 56, via its pinion 58, when the electromechanical motor 54 is activated,
a braking spring 10 arranged so as to be able to generate on the first wheel set 30, as soon as this first wheel set is subjected to a rotary drive torque, a braking torque intended to prevent the display member 48 from trembling, as well as a permanent radial force which keeps the display member in a stable position when it is stationary, and also when it is between driving pulses, and thus prevents this display member from floating.

According to the invention, the electromechanical horological movement 2 comprises a braking device 6 acting on the display wheel set 30 and comprising the braking spring 10 and an intermediate part 8 arranged between the braking spring and an arbor 36 of the first wheel set 30. The braking spring is arranged so as to be able to generate, via the intermediate part against which this braking spring presses, a braking torque on the display wheel set, as soon as this display wheel set is subjected to a rotary drive torque. For this purpose, the intermediate part has a lateral surface 9 pressing against a surface of revolution 35 of the arbor, and a bearing surface 25 against which the braking spring exerts an overall pressing force in the direction of the arbor in order to generate a friction force between the lateral surface 9 and the surface of revolution 35, this friction force generating the braking torque. Thus, the braking torque is exerted on the first wheel set/display wheel set by the braking spring via the intermediate part against which the braking spring presses. The intermediate part 8 and the braking spring 10 are arranged so that the intermediate part remains stationary and non-rotating in normal operation. The arbor 36 of the first wheel set 30 and the intermediate part are configured so that the surface of revolution 35 of the arbor can slide on the lateral surface 9 while being subjected to a dynamic friction force which generates the braking torque. Before the surface of revolution slides on the lateral surface, a static friction force generates the braking torque and thus keeps the arbor stationary.

Preferably, the intermediate part 8 exerts an exclusively radial pressure on the arbor 36 of the first wheel set 30. According to an advantageous feature, the braking spring 10 exerts an exclusively radial overall pressing force on the intermediate part. The bearing surface 25 is opposite the lateral surface 9, i.e. the bearing surface is located on one side of the intermediate part 8 which is opposite another side of this intermediate part defining the lateral surface 9. This alternative embodiment is advantageous because the braking device bears against an undercut part whose radial shake varies little and thus gives a constant braking torque for a given friction force between the surface of revolution 35 and the lateral surface 9. In an advantageous alternative embodiment shown in the figures, the surface of revolution 35 of the arbor 36 is cylindrical and axial and the lateral surface 9 of the intermediate part is axial, i.e. the cylindrical surface of revolution 35 and the lateral surface 9 are oriented along the axis of rotation 42 of the first wheel set 30 which is coincident with the central axis of the arbor 36, the lateral surface 9 and the cylindrical surface of revolution 35 thus being parallel to this axis of rotation 42. In a preferred alternative embodiment, the intermediate part 8 and the braking spring 10 are configured so that said pressing force remains constant once the display wheel set is assembled in the movement and the braking device is fully assembled and adjusted.

According to a main alternative embodiment, the braking spring 10 is a wire spring or a strip spring whose longitudinal axis lies in a geometric plane parallel to a general plane 50 of the electromechanical horological movement 2.

According to the alternative embodiment shown, the intermediate part 8 is a washer having a central cylindrical opening in which, without any interaction from the braking spring 10, the arbor 36 of the first wheel set 30 would slide and rotate freely, said lateral surface 9 of this washer 8 being defined by the cylindrical surface, which is preferably circular (i.e. of revolution), of its central cylindrical opening.

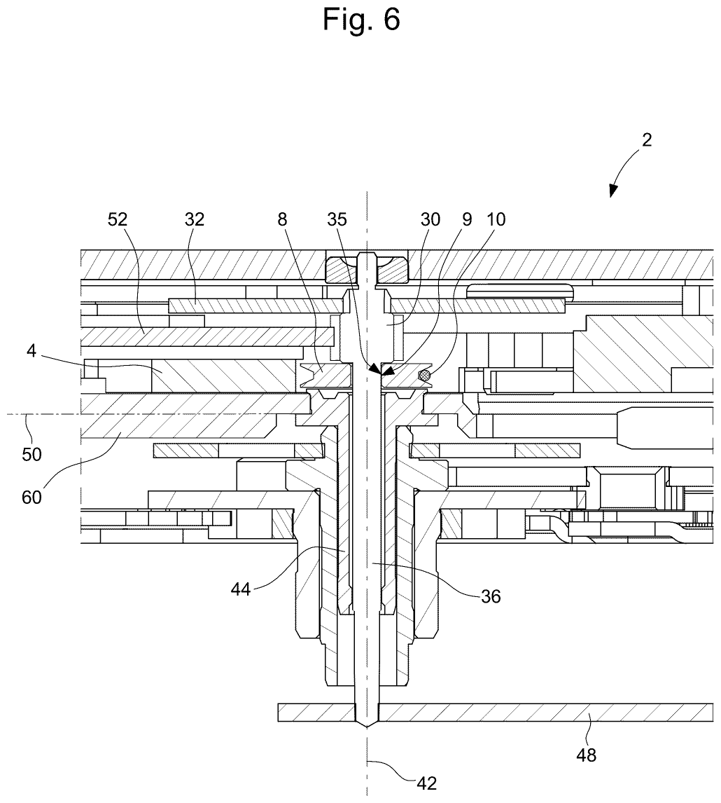

According to a particular alternative embodiment, the washer 8 has, on its periphery, a circular groove 24 defining the bearing surface 25 and into which is at least partially inserted part of the braking spring 10 which exerts the radial pressing force. In particular, the groove 24 has a generally V-shaped cross-section and the braking spring 10 is a wire spring with a circular cross-section, as shown in FIGS. 5 and 6. This arrangement allows the braking spring to be positioned axially in its middle part in contact with the washer. The spring is thus not free to move axially.

By way of non-limiting examples, in a first alternative embodiment, at least the part of the washer 8 defining its central cylindrical opening is made of a Copper Beryllium (CuBe) alloy when at least the part of the arbor defining the surface of revolution 35 is made of steel, or vice versa. This first alternative embodiment gives good tribological results. In a second alternative embodiment where said part of the arbor is made of steel or CuBe, at least the part of the washer defining its central cylindrical opening is made of polymers. Preferably, the entire washer is made of polymers. This second alternative embodiment is particularly advantageous for self-lubrication. In other alternative embodiments in which the arbor is made of steel or a copper alloy (for example CuBe or brass), at least the part of the washer defining its central cylindrical opening is made of bronze, nickel or gold, in particular in the form of a thin layer deposited on a base of another material in the case of nickel or gold, or more typically of a metal alloy containing gold or nickel. In other alternative embodiments, at least the part of the washer defining its central cylindrical opening is made of ceramic, in particular ruby or zirconia.

It should be noted that the material of the braking spring can be selected in such a way as to optimise the resilient nature of this spring and also its manufacture, without having to worry about friction and wear problems, given that the washer and more generally the intermediate part is intended to be static, i.e. stationary and non-rotating, during normal operation of the electromechanical horological movement. In the case of the washer, in order to prevent it from rotating, changes can either be made to the shape of the intermediate part and/or to the shape of the braking spring, as will be explained in more detail below, or changes can be made, in particular in the case of a washer, to the materials used to make the spring and at least the outer part of the intermediate part in contact with the spring and/or to the surface treatment applied to these parts in order to obtain a high friction force between the braking spring and the intermediate part.

According to another preferred alternative embodiment, the braking spring 10 is arranged in the electromechanical horological movement 2 in such a way that a middle part between its two end parts presses radially against the bearing surface 25 of the intermediate part/washer 8. More specifically, the braking spring 10 is arranged so that a middle part of this braking spring exerts said pressing force on the bearing surface 25 of the intermediate part/washer 8. To this end, the two end parts of the braking spring, located respectively on either side of said middle part, are stressed by two distant parts 16 and 20 of the horological movement so that this middle part exerts the pressing force on the bearing surface of the intermediate part/washer. This configuration of the braking device is advantageous because it allows the braking spring to be constantly pressed against the bearing surface of the intermediate part/washer. Moreover, this configuration is less sensitive to vibrations and impacts than if the braking spring had an anchoring point at one of its ends and a contact point at its other end.

In a particular alternative embodiment, the braking spring 10 is curved in its middle part and the bearing surface 25 of the intermediate part/washer 8 has a convex curvature in said geometric plane, relative to the arbor 36 of the first wheel set 30, and in particular a circular curvature in the case of the washer, which is followed, in a first alternative embodiment, by the middle part of the braking spring along the bearing surface. In a second alternative embodiment, the radius of curvature of the middle part is smaller than the average radius of curvature of the bearing surface, so that the braking spring presses against the intermediate part/washer at “two points” of the bearing surface, i.e. at two separate locations. It should be noted that, with a substantially V-shaped groove, a spring with a circular cross-section presses locally at a pair of axially aligned points. Thus, in such a configuration of the groove and of the braking spring, this spring presses at two pairs of points angularly spaced apart from one another, with each pair of points aligned in an axial direction, thus at “two points” projecting in the general plane of the spring, which is parallel to the general plane 50 of the movement. Finally, these alternative embodiments do not exclude other advantageous alternative embodiments in which the average radius of curvature of the middle part is greater than the radius of curvature of the bearing surface, resulting in the radial pressure being exerted at “one point” (i.e. at a pair of points aligned in an axial direction, but at a single point projecting in the general plane of the spring/general plane 50 of the movement).

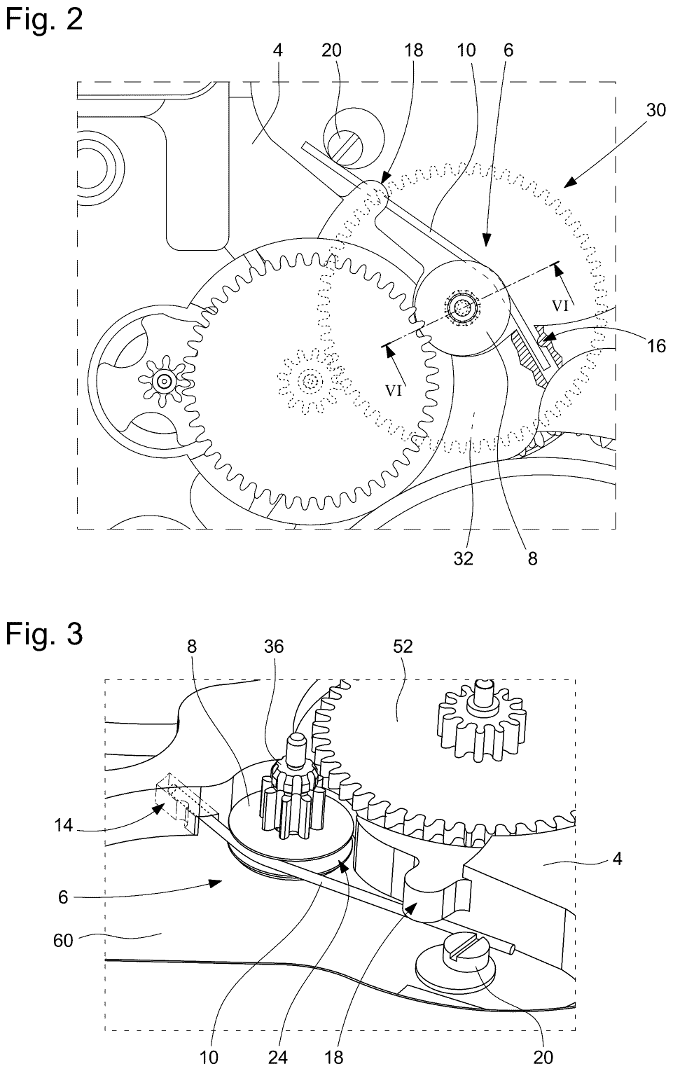

According to an advantageous alternative embodiment, as shown in FIGS. 2 to 4, the braking spring 10 is not fastened to the movement by a specific part, but is held under tension by two parts 16 and 20 of this movement against which press two end portions of the braking spring located respectively on either side of a middle portion of this braking spring bearing radially against the intermediate part, which is in particular the washer 8. The direction of the force applied by the two parts 16 and 20 on the spring is the reverse of the direction of the reaction force of the intermediate part/washer 8 on the middle part of the spring. These forces, which are exerted on the braking spring in the geometric plane (horizontal plane orthogonal to the axis of rotation 42 of the arbor 36 coincident with its central axis) in which its longitudinal axis is located, generate a stress which holds the braking spring in place. Then, to prevent the spring from moving axially/vertically, and in particular its middle part from coming out of the groove 24, two parts of a plate 4 are respectively provided on each of the two said sides, which parts define lower axial stops for the braking spring. On a first side, an upper groove 14 (on the analogue display side) is provided in the plate 4, which is arranged so that its bottom, forming a thin horizontal wall, provides a lower limit for any possible displacement of the part of the spring located on that side. On the second side, the braking spring is partially located above a small projecting part 18. The plate 4 is located below an intermediate plate 60 of the horological movement 2, which defines the general plane 50 of the movement and fixedly supports the base of a tube 44 through which the arbor 36 of the display wheel set 30 passes, the central axis of this tube defining the axis of rotation 42. The intermediate plate 60 defines an upper axial stop for the spring 10. The base of the tube 44 can support the washer 8, particularly when the washer is fitted before the spring is installed, and thus forms a support for the washer. It should be noted that in another alternative embodiment, the element 44 constitutes a barrel which is rotatable.

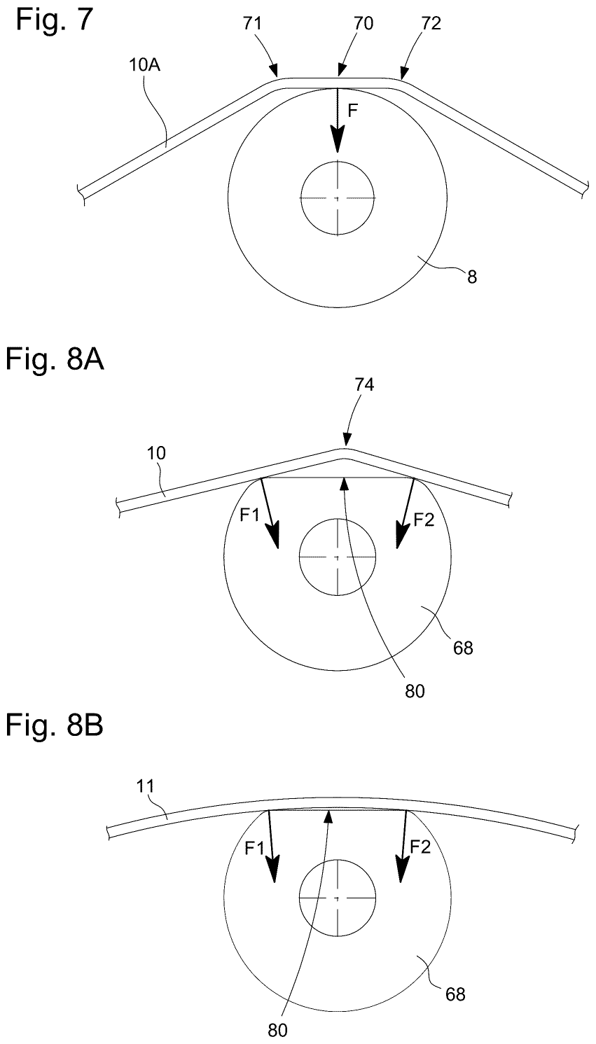

Various other advantageous alternative embodiments are shown diagrammatically in FIGS. 7, 8A and 8B. The alternative embodiment shown in FIG. 7 is characterised by a braking spring 10A with a middle part having two bends 71 and 72 which are separated by a straight section 70 (unstressed), which bears, substantially at its middle, against the circular washer 8. This ensures that the braking spring 10A bears at all times against the washer 8 at “one point”. The alternative embodiments of FIG. 8A to 8B are characterised by an intermediate part 68 which is not circular, but is formed by a truncated washer having a straight zone 80. In the alternative embodiment shown in FIG. 8A, the braking spring 10 has, in its middle part, a bend 74 which is located facing the straight zone 80 of the truncated washer 68. In the alternative embodiment shown in FIG. 8B, the spring 11 is straight/rectilinear without stress and, when it is tensioned to press against the intermediate part, it bends slightly (concave curvature when viewed from the intermediate part) so that it presses at the two ends of the straight zone 80 of this intermediate part. Thus, in the alternative embodiments of FIGS. 8A and 8B, the braking spring 10, or 11 respectively, exerts two forces F1 and F2 respectively at the two ends of the straight zone 80. The two forces F1 and F2 are radial as a whole, i.e. their sum at a mid-point is radial. However, each of the two forces exerts a moment of force on the intermediate part 68, so that if the spring moves longitudinally and one of the two forces F1 and F2 decreases relative to the other, the intermediate part 68 automatically undergoes a small rotation so as to re-establish a balance between the two opposing moments of force exerted thereon. The alternative embodiment shown in FIG. 8B is preferable because there is less risk of rotation of the truncated washer. Moreover, this alternative embodiment allows the desired braking torque to be maintained, even if the braking spring undergoes a certain longitudinal displacement in the event of an impact or sudden acceleration. However, the alternative embodiment shown in FIG. 8A, with a bent spring, is less likely to be subject to longitudinal displacement in the event of an impact. The alternative embodiment with a truncated washer is advantageous for preventing the intermediate part from rotating during normal operation, which is important for ensuring a constant braking torque as set. The alternative embodiments shown in FIGS. 8A and 8B provide support at all times at “two points” projecting in the geometric plane of the spring.

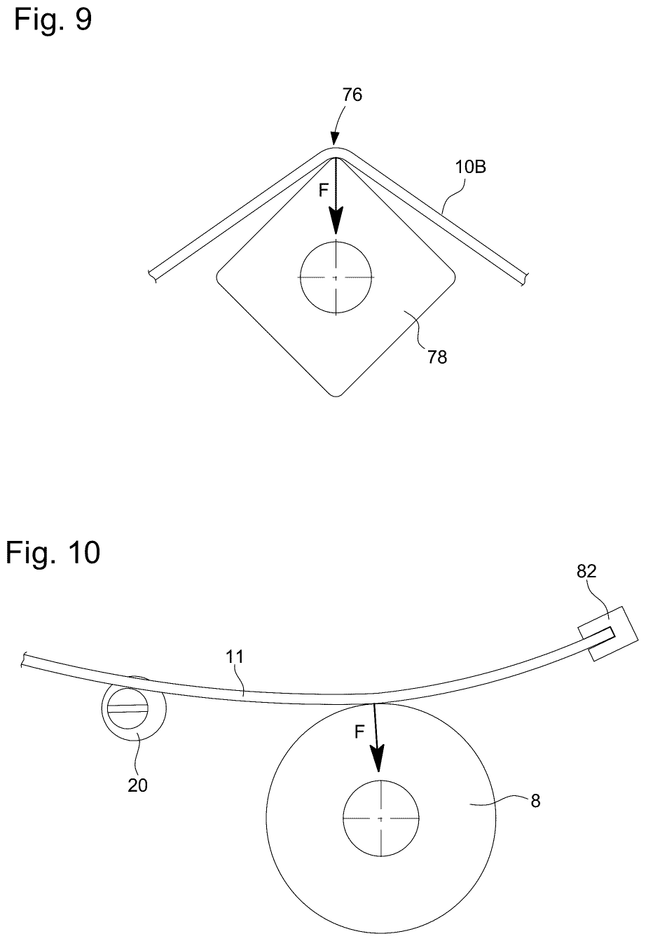

A particular alternative embodiment is diagrammatically shown in FIG. 9. This alternative embodiment, like that of FIG. 7, is designed to ensure that the braking spring 10B is pressed at all times at “one point” on the intermediate part 78, which has an overall square shape with rounded corners. The braking spring 10B has a bend 76 such that the two straight parts of this spring on either side of the bend are at an angle greater than 90° to one another, yet relatively close to this value, for example an angle equal to 110°. One of the rounded corners of the intermediate part is positioned in the bend 76 of the spring which, when this spring and the intermediate part 78 are stationary, exerts a substantially radial force F on the intermediate part. If the spring 10B moves, particularly as the result of an impact, the direction of the force varies so that the intermediate part is then subjected to a moment of force which causes it to rotate. This ensures that the same angle of the square intermediate part remains at all times in the bend 76 of the braking spring and that pressure is applied at “one point”. Furthermore, in normal operation (when the braking spring is stationary), this alternative embodiment keeps the intermediate part stationary (not rotating), thus ensuring a constant, well-defined braking torque on the arbor of the wheel set.

According to a preferred alternative embodiment of the invention, the braking device 6 comprises an eccentric 20 whose axis of rotation is perpendicular to the general plane 50, and thus parallel to the central axis/axis of rotation 42 of the wheel set 30, and which is arranged so as to press radially against the braking spring in order to be able to vary, by rotation about its axis of rotation, said radial pressing force exerted by the braking spring on the intermediate part/washer. In the advantageous alternative embodiment shown in FIGS. 1 and 2, the eccentric 20 constitutes one of the two parts that keep the braking spring under tension. Thus, by turning the eccentric 20, the stress on this spring is varied, making it possible to adjust a braking torque applied to the first wheel set 30 (chronograph wheel set) when it is subjected to a rotary drive torque. This configuration is advantageous because it is not sensitive to vibrations and impacts. In another alternative embodiment, another device for adjusting the radial force is provided, in particular a device fitted with a pressing member capable of being moved linearly.

FIG. 10 shows another embodiment of the invention in which the braking spring 11 is straight/rectilinear (without stress). This spring is rigidly fastened at one of its two ends in a fixed part 82, the angular position of which in the geometric plane cannot be modified, thus preventing any involuntary displacement or displacement due to an impact. The groove in the part 82 into which the end of the spring 11 is inserted is oriented so that a middle zone of the spring exerts a radial pressing force F on the washer 8, this spring then having a first convex curvature (when viewed from the washer) between the fastening part 82 and the bearing point of the spring on the washer. Preferably, at the other end of the spring, to adjust the radial force F, an eccentric is provided which, in this embodiment, is located on the same side of the braking spring as the washer 8 which forms the intermediate part between the braking spring and the arbor of the wheel set concerned. Thus, the braking spring 11 also has a second convex curvature between said bearing point and the eccentric 20, this second curvature being less than the first curvature because the radial force F is not zero. It should be noted that the alternative embodiment shown in FIG. 10 defines a construction of the type having a single bearing point, i.e. with the braking spring bearing on the washer at “one point”, according to the definition given above. In another alternative embodiment of the “two points” type, a star-shaped intermediate part is provided, for example with four to six tips each having a small, rounded portion. The slightly convex braking spring bears at all times on two tips of the star-shaped intermediate part, thus exerting two forces which form, at their central point, a radial overall pressing force. In other words, the two forces generate two opposing moments of force on the intermediate part that are of equal intensity. It should also be noted that in the event of an impact, the braking device cannot be deregulated.

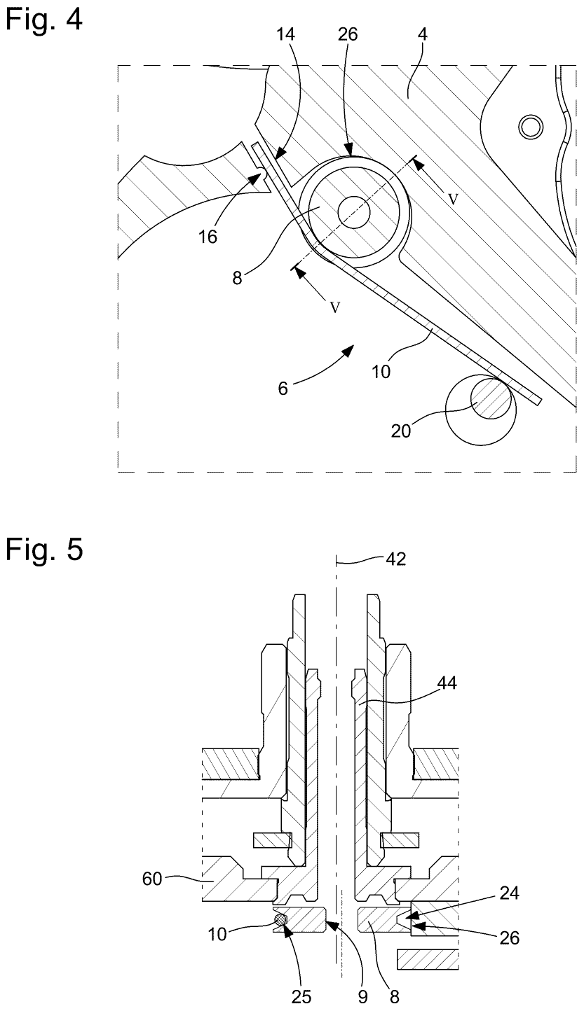

FIGS. 4 and 5 show the electromechanical horological movement 2 with the braking device 6 preassembled in a preliminary step prior to the assembly of the first wheel set 30. This preliminary assembly of the braking device 6 is advantageous. It is made possible in particular by the fact that the force exerted by the braking spring is radial and by the fact that the washer 8 is provided above a pinion and a wheel 32 forming the first wheel set. Thus, the arbor 36 of the first wheel set can be mounted from beneath the horological movement and through the central opening in the washer 8. FIGS. 1 to 3 and 6 show the electromechanical horological movement 2 after the first wheel set 30 has been mounted in this movement and the braking device in an operational state.

To allow preliminary assembly of the braking device 6, the washer 8 is arranged on a support (base of the tube 44), at the plate 4, which has, on the periphery of the washer, an abutment surface 26 located horizontally facing the washer and diametrically opposite said bearing surface 25, so that the washer 8 and the braking spring 10 can be preassembled in the electromechanical horological movement 2, before assembly of the first wheel set 30, with the washer bearing against the abutment surface 26, as shown in FIGS. 4 and 5.

In a preferred alternative embodiment, the abutment surface 26 is arranged so that, following prior assembly of the washer 8 and the braking spring 10, the central cylindrical opening in the washer has at least one zone that is superimposed with the central circular opening in a pipe or tube 44, into which part of the arbor 36 of the first wheel set 30 is subsequently inserted, so that when the first wheel set is mounted in the electromechanical horological movement 2, the arbor can penetrate the two central openings without initially having to exert a radial force on the washer. As can be seen in FIG. 5, in the alternative embodiment shown, the central cylindrical opening in the washer 8 is not entirely superimposed on the central circular opening in the tube 44. Preferably, at least most of the opening in the washer is superimposed on the central opening in the tube. In the example shown, it should be noted that the arbor 36 of the first wheel set 30 is inserted into a tube 44 which is unmoving. The upper end of the arbor, intended to receive a seconds hand, has a smaller diameter, which makes it easier to insert this arbor into the two central openings, during the assembly of the display wheel set 30, when the initial superposition of the two central openings, when the braking device is in the pre-assembled state, is only partial.

Once the first wheel set 30 is assembled in the horological movement, the washer 8 no longer bears against the side wall 26 of the plate 4, but bears, via its central cylindrical opening, against the arbor 36 of the first wheel set, more precisely against a surface of revolution 35, which is advantageously cylindrical and axial, of this arbor. This first wheel set can then be driven rotatably at times, on command, by the electromechanical motor 54 via the second wheel set 52.

The present invention has been described in detail for a seconds wheel set 30, but the braking device of the invention can be provided for other wheel sets of an electromechanical horological movement, in particular for a minutes wheel set or for a chrono wheel set.

The invention has several advantages, some of which have already been described. The braking device 6 comprises an eccentric 20 which makes it easy to adjust the radial pressing force exerted by the braking spring on the intermediate part/washer 8 and via this the radial force applied to the arbor 36 of the first wheel set 30, and to adjust the moment of frictional force applied to this first wheel set. The eccentric 20 allows the braking torque to be adjusted once the braking device has been fully mounted in the electromechanical horological movement and without having to remove the braking spring in order to slightly modify its initial shape. Given the presence of the washer 8 between the braking spring 10 and the arbor 36, and in addition to the fact that the forces involved are intended to be radial, the fitting of the seconds hand 48 on the first wheel set 30 and especially its removal, for example when this hand is changed or when cleaning the electromechanical horological movement, cannot damage the braking spring which is the delicate element in the braking device 6, the washer 8 being much more robust and able to withstand a certain amount of axial pressure against its support.

The braking device 6 is such that it is protected against stresses that could damage it during the assembly of other parts of the electromechanical horological movement, in particular during the assembly of the display wheel set 30. When the horological movement 2 is removed, and in particular when the display wheel set is removed, the braking device 6 can remain in place without altering its settings.

The braking device according to the invention makes it possible to predetermine the moment of frictional force relatively precisely, since the lateral surface 9 of the intermediate part, in particular of the washer 8, has a height which is generally much greater than that of the braking spring, since the material of the intermediate part/washer 8 can be selected and since the diameter of the surface of revolution, defining a cylindrical and axial surface, of the arbor 36 against which the intermediate part/washer 8 bears is precisely determined.

1. An electromechanical horological movement comprising an electromechanical motor, a display wheel set arranged to be rotated by the electromechanical motor and comprising an arbor intended to carry a display member, and a braking device associated with the display wheel set and comprising a braking spring and an intermediate part arranged between the braking spring and the arbor of the display wheel set, the braking spring being arranged so as to be able to generate, via the intermediate part against which this braking spring presses, a braking torque on the display wheel set, as soon as this display wheel set is subjected to a rotary drive torque, the intermediate part and the braking spring being arranged so that the intermediate part remains stationary and non-rotating in normal operation, the intermediate part having a lateral surface pressing against a surface of revolution of said arbor, and a bearing surface against which the braking spring exerts an overall pressing force towards said arbor in order to generate a friction force between the lateral surface and the surface of revolution that generates said braking torque.

2. The horological movement according to claim 1, wherein the intermediate part exerts exclusively radial pressure on the arbor of the display wheel set.

3. The horological movement according to claim 1, wherein the arbor defines a central axis, wherein said surface of revolution is cylindrical and axial and said lateral surface is axial.

4. The horological movement according to claim 1, wherein the braking spring is a wire spring or a strip spring whose longitudinal axis is located in a geometric plane parallel to a general plane of the movement.

5. The horological movement according to claim 4, wherein the braking spring is arranged so that a middle part of this braking spring exerts said pressing force on said bearing surface of the intermediate part; and wherein two end parts of the braking spring, located respectively on either side of said middle part, are stressed by two distant parts of the horological movement so that this middle part exerts the pressing force on said bearing surface.

6. The horological movement according to claim 5, wherein the braking spring is not fastened to the horological movement but is held under tension by said distant parts of this horological movement against which said two end parts of the braking spring press in two respective directions in said geometric plane.

7. The horological movement according to claim 5, wherein this movement comprises an eccentric whose axis of rotation is perpendicular to said geometric plane and which is arranged so as to press against the braking spring in order to be able to vary, by rotation about its axis of rotation, said pressing force exerted by the braking spring on the intermediate part.

8. The horological movement according to claim 1, wherein the intermediate part is a washer having a central opening through which the arbor of the display wheel set passes, said lateral surface of this washer being defined by a cylindrical surface of its central opening.

9. The horological movement according to claim 8, wherein the washer has, on its periphery, a groove defining said bearing surface and into which is inserted at least partially a part of the braking spring exerting said pressing force in the direction of said arbor.

10. The horological movement according to claim 1, wherein the intermediate part is arranged facing an abutment surface which is diametrically opposite said bearing surface, so that the intermediate part and the braking spring can be preassembled in the electromechanical horological movement, before assembling the display wheel set, with the intermediate part bearing against the abutment surface.

11. The horological movement according to claim 10, wherein the abutment surface is arranged in such a way that, following prior assembly of the intermediate part and of the braking spring, the central cylindrical opening in the intermediate part has at least one zone that is superimposed with the central cylindrical opening in a pipe or tube, which is rotatable or fixed, into which part of the arbor of the display wheel set is inserted, so that the arbor can, when the display wheel set is mounted in the electromechanical horological movement, penetrate the two central circular openings without initially having to exert a radial force on the intermediate part.

12. The horological movement according to claim 1, wherein at least part of the arbor defining said surface of revolution is made of steel or consists of a copper alloy and at least part of the intermediate part defining said lateral surface consists of a copper alloy or steel respectively.

13. The horological movement according to claim 1, wherein at least part of the arbor defining said surface of revolution is made of steel or consists of a copper alloy and at least part of the intermediate part defining said lateral surface consists of polymers.

14. The horological movement according to claim 1, wherein at least part of the arbor defining said surface of revolution is made of steel or consists of a copper alloy and at least part of the intermediate part defining said lateral surface consists of a ceramic, including ruby or zirconia, or of a material containing gold or nickel and forming an outer layer at least partially covering the intermediate part.
